(19) United States
(12) Patent Application Publication
(10) Pub. No.: US 2025/0242822 A1
(43) Pub. Date: Jul. 31, 2025

(54) CONTROLLING VEHICLE OPERATION BASED ON DRIVER ATTENTIVENESS

(71) Applicant: Robert Bosch GmbH, Stuttgart (DE)

(72) Inventors: Lucas Ringe, Westland, MI (US); Rohit Noheria, Novi, MI (US)

(21) Appl. No.: 18/423,982

(22) Filed: Jan. 26, 2024

(51) Int. Cl. B60W 50/14; G06F 3/01; G06V 20/59; G08B 21/18

(52) U.S. Cl. CPC B60W 50/14; G06F 3/012; G06F 3/013; G06V 20/597; G08B 21/182; B60W 2540/225; B60W 2540/229

(57) ABSTRACT

A system for controlling a forward collision warning system based on a driver attentiveness value is provided. The system includes a plurality of sensors and an electronic processor. The electronic processor is configured to determine a gaze angle of a driver using the plurality of sensors; determine a driver attentiveness value based on the gaze angle; determine a forward collision warning system activation threshold based on the driver attentiveness value; and selectively activate the forward collision warning system based on the forward collision warning system activation threshold.

### SUMMARY

Modern vehicles include numerous safety features that are designed to help keep occupants safe and to help avoid collisions. These safety features are often part of one of more advanced driver-assistance systems (ADASs). ADASs include, for example, adaptive cruise control, adaptive steering or lane keep features, and forward collision warning. In some instances, all or a combination of these features are included a vehicle. Adaptive cruise control maintains the speed of the vehicle at a value set by the driver. Adaptive steering helps keep a vehicle within a road or highway lane and, in some instances, may override or modify steering inputs from a driver. Forward collision warning can alert a driver when the vehicle that the driver is operating is getting too close to a forward vehicle.

One example implementation provides a system for controlling a forward collision warning system based on a driver attentiveness value. The system includes a plurality of sensors and an electronic processor. The electronic processor is configured to determine a gaze angle of a driver using the plurality of sensors; determine a driver attentiveness value based on the gaze angle; determine a forward collision warning system activation threshold based on the driver attentiveness value; and selectively activate the forward collision warning system based on the forward collision warning system activation threshold.

The electronic processor is further configured to monitor a forward collision warning system activation value and activate the forward collision warning system when the forward collision warning system activation value is less than the forward collision warning system activation threshold.

The gaze angle is measured between a longitudinal axis of a vehicle and a direction in which the driver is looking.

The plurality of sensors includes at least a time-of-flight camera with a field of view of an interior of a vehicle.

The time-of-flight camera determines a direction in which the driver is looking, a head position of the driver, a body position of the driver, or a combination thereof to determine the gaze angle.

The gaze angle is compared to a lookup table of predetermined gaze angles to determine the driver attentiveness value.

The driver attentiveness value decreases as the gaze angle increases.

The driver attentiveness value is compared to a lookup table of predetermined driver attentiveness values to determine the forward collision warning system activation threshold.

The forward collision warning system activation threshold increases as the driver attentiveness value decreases.

Another example implementation provides a system for controlling a forward collision warning system based on a driver attentiveness value. The system includes a plurality of sensors and an electronic processor. The electronic processor is configured to determine a driver attentiveness value for a driver, modifying a forward collision warning system activation threshold based on the driver attentiveness value, and selectively activate the forward collision warning system based on the forward collision warning system activation threshold.

The driver attentiveness value is at least partially based on a gaze angle of the driver and the gaze angle is determined based on a direction in which the driver is looking, a head position of the driver, a body position of the driver, or a combination thereof.

The plurality of sensors includes a time-of-flight camera and the time-of-flight camera detects the direction in which the driver is looking, the head position of the driver, the body position of the driver, or a combination thereof.

The system further includes a memory coupled to the electronic processor and the memory includes a first lookup table that includes a plurality of predetermined gaze angles and a plurality of driver attentiveness values, wherein each of the plurality of driver attentiveness values is associated with a respective predetermined gaze angle.

The memory further includes a second lookup table that includes a plurality of forward collision warning system activation thresholds and the plurality of driver attentiveness values, wherein each forward collision warning system activation threshold is associated with a respective driver attentiveness value.

Still another example implementation provides a method of controlling a forward collision warning system based on a driver attentiveness value. The method includes determining a driver attentiveness value for a driver, determining a forward collision warning system activation threshold based on the driver attentiveness value, and selectively activating the forward collision warning system based on the forward collision warning system activation threshold.

The method further comprises monitoring a gaze location associated with the driver using a time-of-flight camera having a field of view of an interior of a vehicle in which the driver is located, wherein the gaze location is based on a direction in which the driver is looking, a head position of the driver, a body position of the driver, or a combination thereof.

The method further includes determining a gaze angle from the gaze location, wherein the gaze angle is measured between a gaze axis aligned with the gaze location of the driver and a drive axis aligned with a longitudinal axis of the vehicle.

The method further includes comparing the gaze angle to a gaze angle lookup table to determine the driver attentiveness value.

The method further includes comparing the driver attentiveness value to a driver attentiveness value lookup table to determine the forward collision warning system activation threshold.

The method further includes monitoring a forward collision warning system activation value and selectively activating the forward collision warning system when the forward collision warning system activation value is less than the forward collision warning system activation threshold.

### BRIEF DESCRIPTION OF THE DRAWINGS

FIG. 1 is a schematic diagram of a decentralized vehicle operating system.

FIG. 2 is a schematic diagram of a centralized vehicle operating system.

FIG. 3 is a flowchart illustrating an example method of determining a driver attentiveness based on a driver gaze angle.

FIG. 4 is a first overhead view of an example vehicle.

FIG. 5 is a second overhead view of the vehicle of FIG. 4.

FIG. 6 is a third overhead view of the vehicle of FIG. 4.

FIG. 7 is a diagram illustrating an example of driver gaze zones.

FIG. 8 is a flowchart illustrating an example method of controlling a vehicle operation based on a driver attentiveness value.

### DETAILED DESCRIPTION

Before any aspects, features, or instances are explained in detail, it is to be understood that the aspects, features, or instances are not limited in their application to the details of construction and the arrangement of components set forth in the following description or illustrated in the following drawings. Other instances are possible and are capable of being practiced or of being carried out in various ways.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

For ease of description, some or all of the example systems presented herein are illustrated with a single exemplar of each of its component parts. Some examples may not describe or illustrate all components of the systems. Other instances may include more or fewer of each of the illustrated components, may combine some components, or may include additional or alternative components.

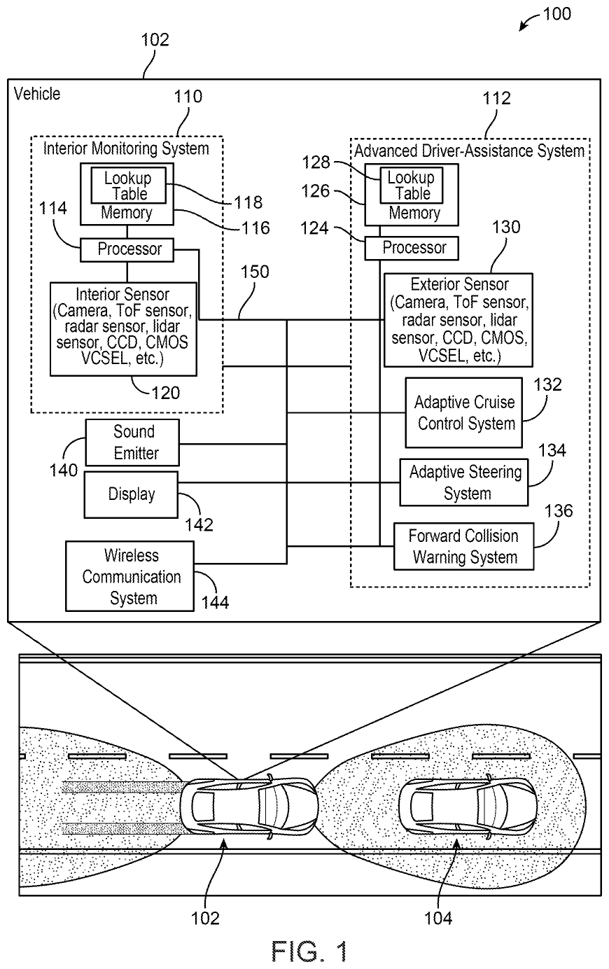

FIG. 1 illustrates an example system 100 for controlling vehicle operation based on driver attentiveness. In the example shown, the system 100 resides in a primary vehicle 102 which is adjacent a secondary vehicle 104. It can be appreciated that both vehicles 102, 104 may include the same system 100 described herein. However, for clarity and easy of understanding, the details of the system 100 are described in the context of the primary vehicle 102 and the secondary vehicle 104 is included to aid in the description of the operation of the system 100.

As shown, the system 100 includes an interior monitoring system 110 and an advanced driver-assistance system 112. The interior monitor system 110 includes an electronic processor 114 connected to a memory 116. In one example, the memory 116 includes a lookup table 118 that stores values related to a driver gaze angle, i.e., the direction that a driver is looking relative to forward direction or direction in which the vehicle is moving. In some instances, other data structures to store and access data are used in place of or in addition to a lookup table. These values include a driver attentiveness value associated with driver gaze angles. As further shown, the interior monitoring system 110 also includes an interior sensor 120 coupled to the electronic processor 114. In some instances, more than one interior sensor is used. In some instances, the interior sensor 120 includes or takes the form of a camera, a time-of-flight (ToF) sensor, a radar sensor, a lidar sensor, or a combination thereof. Further, the interior sensor 120 can include a charge-coupled device (CCD), a complementary metal-oxide-sensor (CMOS), or a vertical-cavity surface-emitting laser (VCSEL).

The interior sensor 120 is used to monitor the driver and the direction in which the driver is looking during operation of the vehicle 102 to determine a real-time gaze angle associated with the driver. The gaze angle is used to determine a driver attentiveness value. For example, as the gaze angle increases (and the driver is not looking in the direction of travel for the vehicle, the driver attentiveness value decreases.

As shown in FIG. 1, the advanced driver-assistance system 112 includes an electronic processor 124 connected to a memory 126. The memory 126 includes a lookup table 128 (or other access and storage data structure) that stores values related to a forward collision warning (FCW) activation threshold based on driver attentiveness values. For example, as the driver attentiveness value decreases, the forward collision warning system activation threshold increases. Increasing the activation threshold provides the driver greater warning (e.g., greater time) concerning a nearby vehicle, e.g., the secondary vehicle 104, to help reduce the likelihood of a collision between the primary vehicle 102 and the secondary vehicle 104. Further, increasing the activation threshold also allows for an increased reaction time for the driver of the primary vehicle 102 and increases the gap between the primary vehicle 102 and the secondary vehicle 104.

In the example shown, the advanced driver-assistance system 112 also includes an exterior sensor 130 coupled to the processor 124. In some instances, the exterior sensor 130 includes or takes the form of a camera, a time-of-flight (ToF) sensor, a radar sensor, a lidar sensor, or a combination thereof. Further, the exterior sensor 130 can include a charge-coupled device (CCD), a complementary metal-oxide-sensor (CMOS), or a vertical-cavity surface-emitting laser (VCSEL). In the example shown, the advanced driver-assistance system 112 includes an adaptive cruise control system 132, an adaptive steering system 134, and a forward collision warning system 136 connected to the processor 124.

The exterior sensor 130 may be located on the front of the primary vehicle 102 (for example, the exterior sensor 130 may be mounted to a grill or location between the vehicle's headlights) to detect a distance between the primary vehicle 102 and the secondary vehicle 104. In some instances, more than one exterior sensor 130 is used and the exterior sensors are located one each side of the primary vehicle 102 to detect vehicles adjacent the sides of the primary vehicle 102.

During operation of the primary vehicle 102, the adaptive cruise control system 132 controls the speed of the primary vehicle 102 (for example, by controlling the throttle or acceleration and/or braking systems of the primary vehicle 102) to maintain a pre-determined distance between the primary vehicle 102 and the secondary vehicle 104 based on information sensed by the exterior sensor 130. For example, the exterior sensor 130 (or an electronic processor that is a part of or connected to the electronic sensor 130) determines a distance between the primary vehicle 102 and the secondary vehicle 104. If the distance between the primary vehicle 102 and the secondary vehicle 104 is less than an FCW system activation threshold, the FCW system 136 may alert the driver of a pending collision situation, for example, by sounding an alarm or activating a warning light. If the distance between the primary vehicle 102 and the secondary vehicle 104 decreases further, the adaptive cruise control system 132 may apply the brakes of the primary vehicle 102 to help prevent a collision. It is to be understood that the adaptive steering system 134 assists the driver when steering the primary vehicle 102 and may prevent lane changes when another vehicle is sensed on either side of the primary vehicle 102 by the exterior sensor 130.

In the example shown FIG. 1, the system 100 also includes a sound emitter 140 and a display 142 connected to the interior monitoring system 110 and to the advanced driver-assistance system 112. The sound emitter 140 emits one or more warning signals such as an audible alarm, a spoken message, or a combination thereof. Moreover, a wireless communication system 144 is connected to the interior monitoring system 110 and to the advanced driver-assistance system 112. The display 142 can include a heads-up display, an infotainment system display, a warning light, or any combination thereof. For example, the sound emitter 140 can work in conjunction with the FCW system 136 to emit an audible alarm or signal to a driver when the primary vehicle 102 is too close to another vehicle, e.g., the secondary vehicle 104, during operation of the primary vehicle 102.

The various components of the system 100, along with other various modules and components are electrically and communicatively coupled to each other via direct connections or by or through one or more control or data buses (for example, the bus 150), which enable communication therebetween. In some instances, the bus 150 is a Controller Area Network (CAN™) bus. In some instances, the bus 150 is an automotive Ethernet™, a FlexRay™ communications bus, or another suitable bus. In alternative instances, some or all of the components of the system 100 may be communicatively coupled using suitable wireless modalities (for example, Bluetooth™ or near field communication connections).

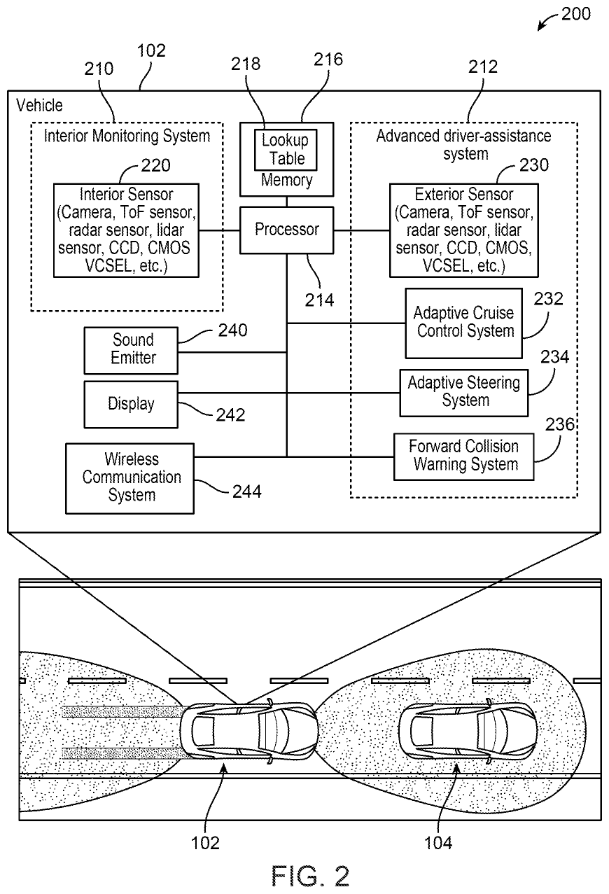

FIG. 2 illustrates a similar system 200 that utilizes a single centralized processor. As shown, the system 200 resides in a primary vehicle 102. A secondary vehicle 104 is included to assist in the description of the operation of the system. The system 200 depicted in FIG. 2 includes an interior monitoring system 210 and an advanced driver-assistance system 212 connected to a processor 214. A memory 216 is connected to the processor 214 and the memory 216 includes a lookup table 218. In this instance, the lookup table 218 stores data associated with the interior monitoring system 210 and the advanced driver-assistance system 212. For example, the lookup table 218 stores values related to a driver gaze angle and values related to a forward collision warning (FCW) activation based on driver attentiveness values.

The interior monitoring system 210 also includes an interior sensor 220 coupled to the processor 214. In some instances, the interior sensor 120 includes or takes the form of a camera, a time-of-flight (ToF) sensor, a radar sensor, a lidar sensor, or a combination thereof. Further, the interior sensor 120 can include a charge-coupled device (CCD), a complementary metal-oxide-sensor (CMOS), or a vertical-cavity surface-emitting laser (VCSEL). The interior sensor 220 is used to monitor the driver and the direction in which the driver is looking during operation of the vehicle 202 to determine a real-time gaze angle associated with the driver. The gaze angle is used to determine a driver attentiveness value.

FIG. 2 indicates that the advanced driver-assistance system 212 includes an exterior sensor 230 coupled to the processor 224. In some instances, the exterior sensor 230 includes or takes the form of a camera, a time-of-flight (ToF) sensor, a radar sensor, a lidar sensor, or a combination thereof. Further, the exterior sensor 230 can include a charge-coupled device (CCD), a complementary metal-oxide-sensor (CMOS), or a vertical-cavity surface-emitting laser (VCSEL). Moreover, the advanced driver-assistance system 212 includes an adaptive cruise control system 232, an adaptive steering system 234, and a forward collision warning system 236 connected to the processor 224.

The exterior sensor 230 may be located on the front of the primary vehicle 102 (for example, the exterior sensor 230 may be mounted to a grill or location between the vehicle's headlights) to detect a distance between the primary vehicle 102 and the secondary vehicle 104. In some instances, more than one exterior sensor 230 is used and the exterior sensors are located one each side of the primary vehicle 102 to detect vehicles adjacent the sides of the primary vehicle 102.

During operation of the primary vehicle 202, the adaptive cruise control system 232 controls the speed and/or braking of the primary vehicle 202 to maintain a safe distance between the primary vehicle 202 and the secondary vehicle 204 based on information sensed by the exterior sensor 230. For example, the exterior sensor 230 can determine a distance between the primary vehicle 202 and the secondary vehicle 204. If the distance between the primary vehicle 202 and the secondary vehicle 204 is less than an FCW system activation threshold, the FCW system 236 may alert the driver of a pending collision situation sounding an alarm. If the distance between the primary vehicle 202 and the secondary vehicle 204 decreases further, the adaptive cruise control system 232 may apply the brakes of the primary vehicle 202 to prevent a collision. It is to be understood that the adaptive steering system 234 assists the driver when steering the primary vehicle 202 and may prevent lane changes when another vehicle is sensed on either side of the primary vehicle 202 by the exterior sensor 230.

FIG. 2 indicates that the system 200 further includes a sound emitter 240 and a display 242 connected to the interior monitoring system 210 and to the advanced driver-assistance system 212. The sound emitter 240 emits one or more warning signals such as an audible alarm, a spoken message, or a combination thereof. Moreover, a wireless communication system 244 is connected to the interior monitoring system 210 and to the advanced driver-assistance system 212. The display 242 can include a heads-up display, an infotainment system display, a warning light, or any combination thereof. For example, the sound emitter 240 can work in conjunction with the FCW system 236 to emit an audible alarm or signal to a driver when the primary vehicle 202 is too close to another vehicle, e.g., the secondary vehicle 204, during operation of the primary vehicle 202.

The various components of the system 200, along with other various modules and components are electrically and communicatively coupled to each other via direct connections or by or through one or more control or data buses (for example, the bus 250), which enable communication therebetween. In some instances, the bus 250 is a Controller Area Network (CAN™) bus. In some instances, the bus 250 is an automotive Ethernet™, a FlexRay™ communications bus, or another suitable bus. In alternative instances, some or all of the components of the system 200 may be communicatively coupled using suitable wireless modalities (for example, Bluetooth™ or near field communication connections).

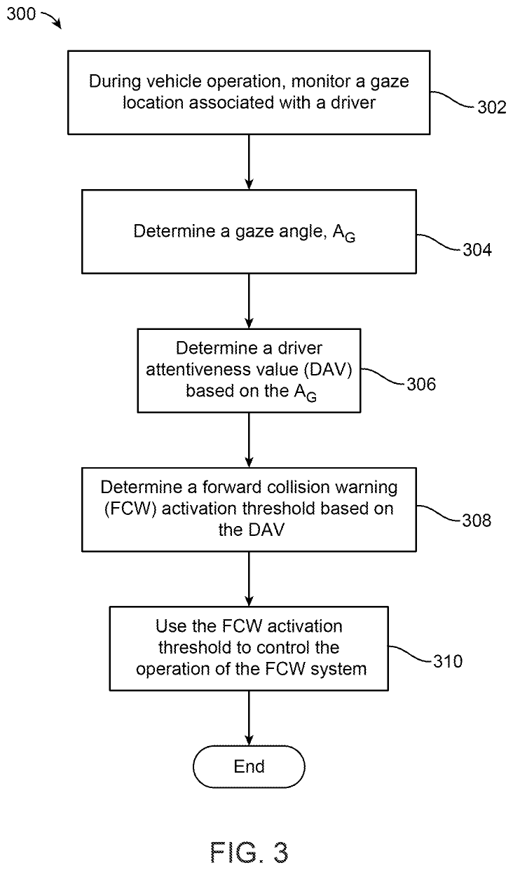

FIG. 3 illustrates an example method of determining a driver attentiveness value (DAV) that is generally designated 300. The DAV is used to set a forward collision warning (FCW) activation threshold. For example, the FCW system activation threshold may be a threshold distance between the primary vehicle 102 and the secondary vehicle 104 and if the actual distance between the primary vehicle 102 and the secondary vehicle 104 falls below the FCW system activation threshold, the FCW system is activated and a warning is sent to the driver of the primary vehicle 102. The steps of the method 300 may be executed by the distributed system 100 depicted in FIG. 1 or the centralized system 200 depicted in FIG. 2. In the case of the distributed system 100, the steps of the method 300 may be executed by the processor 114 of the interior monitoring system 110, the processor 124 of the advanced driver-assistance system 112, or a combination thereof. On the other hand, in the case of the centralized system 200, the steps of the method 300 may be executed by the processor 214.

As shown in FIG. 3, the method 300 commences at step 302, wherein during vehicle operation, the method 300 includes monitoring a gaze location associated with a driver. The gaze location is the direction in which the driver is looking and the gaze location can be determined using an interior sensor such as the interior sensor 120, 220 of the first system 100 or the second system 200. As previously disclosed, the interior sensor 120, 220 may include a camera having a field of view of the interior of the primary vehicle 102 and the camera is used to determine the gaze location by monitoring the direction of the driver's eyes, the direction of the driver's head, the direction of the driver's shoulders, or a combination thereof. For example, the camera may be a time-of-flight (ToF) camera that uses lidar, infrared light pulses, or a combination thereof to determine a direction in which a driver is looking relative to a fixed point or fixed axis, a head position of the driver relative to a fixed point or fixed axis, a body of the driver relative to a fixed point or fixed axis, or any combination thereof.

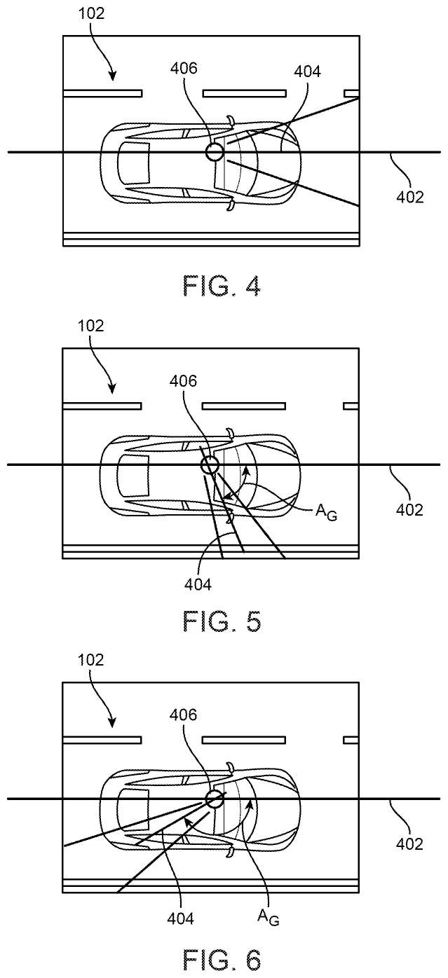

Moving to step 304, the method 300 includes determining a gaze angle, A_{G}, from the gaze location. Referring to FIGS. 4-5, the gaze angle, A_{G}, is measured between the drive axis 402 of the primary vehicle 102 and a gaze axis 404 aligned with the gaze location of the driver 406. It is to be understood that the drive axis 402 is aligned with a longitudinal axis of the primary vehicle 102. As shown in FIG. 4, when the driver 406 is looking in the same direction of travel as the vehicle, i.e., forward, the gaze axis 404 is aligned with the drive axis 402 and the gaze angle, A_{G}, is zero degrees (0°). Further, as shown in FIG. 4, when the driver 406 is looking to the side, e.g., to the right side of the vehicle at something in the passenger seat or something outside the vehicle, as detected by the eye position and head position, the gaze axis 404 is misaligned with the drive axis 402 and the gaze angle, A_{G}, increases. In the example illustrated in FIG. 5, the gaze angle, A_{G}, is sixty-seven and one-half degrees (67.5°). As shown in FIG. 6, when the driver 406 is looking further rearward in the primary vehicle 102, as detected by the head position and shoulder position, the gaze axis 404 is further misaligned with the drive axis 402 and the gaze angle, A_{G}, is even greater than previously demonstrated. In the example of FIG. 6, the gaze angle, A_{G}, is one-hundred and fifty degrees (150°). Clearly, as the gaze angle, A_{G}, increases the driver 406 will be further distracted from whatever is ahead of the primary vehicle 102.

Returning to the description of the method 300, at step 306 the method 300 includes determining a driver attentiveness value (DAV) based on the gaze angle, A_{G}. To determine a particular DAV in real-time, the processor 114, 214 can access a lookup table 118, 218 which stores various DAVs associated with each gaze angle, A_{G}, or ranges of gaze angles, A_{G}. For example, for a gaze angle, A_{G}, that is equal to zero (0°), the DAV may be one (1.0). As the gaze angle, A_{G}, increases the DAV may decrease. Table 1, below, shows various DAVs for various gaze angles, A_{G}. Table 2 shows various DAVs for various ranges of gaze angles, A_{G}.

TABLE 1
DAV vs. Gaze Angle, A_{G}.

| A_{G} | DAV |
|---|---|
| 0° | 1.0 |
| 15° | 0.875 |
| 30° | 0.75 |
| 45° | 0.625 |
| 60° | 0.5 |
| 75° | 0.375 |
| 90° | 0.25 |
| 105° | 0.125 |
| 120° | 0.0 |

Table 2. DAV vs. Gaze Angle, A_{G}, Ranges
A_{G} Range DAV
0°-14° 1.0
15°-30° 0.875
91°-104° 0.25
105°-119 0.125
120°-above 0.0

Returning to the description of the method 300, at step 308, the method 300 includes determining a forward collision warning (FCW) activation threshold based on the DAV. To determine a particular FCW system activation threshold in real-time, the processor 124, 214 can access a lookup table 128, 218 which stores various FCW system activation thresholds associated with each DAV. For example, for a DAV that is equal to one (1), the FCW system activation threshold may be set to a minimum FCW system activation threshold of one hundred feet. The minimum FCW system activation threshold may be a user preferred setting stored in the system. As the DAV, decreases the FCW system activation threshold increases.

Table 3, below, shows various FCW system activation thresholds, measured in distance between the primary vehicle 102 and the secondary vehicle 104, for various DAVs for a vehicle traveling at 55 mph corresponding to a three second gap between the primary vehicle 102 and the secondary vehicle 104 as a minimum distance. Each increase in feet represents a one second increase in the time between the primary vehicle 102 and the secondary vehicle 104.

TABLE 3
FCW system activation Threshold for DAV at 55 mph.

| | FCW system activation |
|---|---|
| DAV | Threshold (feet) |
| 1.0 | 242 |
| 0.875 | 323 |
| 0.75 | 403 |
| 0.625 | 484 |
| 0.5 | 565 |
| 0.375 | 645 |
| 0.25 | 726 |
| 0.125 | 807 |
| 0.0 | 887 |

Table 4, below, shows various FCW system activation thresholds, measured in distance between the primary vehicle 102 and the secondary vehicle 104, for various DAVs for a vehicle traveling at 65 mph corresponding to a three second gap between the primary vehicle 102 and the secondary vehicle 104 as a minimum distance. Each increase in feet represents a one second increase in the time between the primary vehicle 102 and the secondary vehicle 104.

TABLE 4
FCW system activation Threshold for DAV at 65 mph.

| | FCW system activation |
|---|---|
| DAV | Threshold (feet) |
| 1.0 | 286 |
| 0.875 | 381 |
| 0.75 | 477 |
| 0.625 | 572 |
| 0.5 | 667 |
| 0.375 | 763 |
| 0.25 | 858 |
| 0.125 | 953 |
| 0.0 | 1049 |

Table 5, below, shows various FCW system activation thresholds, measured in distance between the primary vehicle 102 and the secondary vehicle 104, for various DAVs for a vehicle traveling at 75 mph corresponding to a three second gap between the primary vehicle 102 and the secondary vehicle 104 as a minimum distance. Each increase in feet represents a one second increase in the time between the primary vehicle 102 and the secondary vehicle 104.

TABLE 5
FCW system activation Threshold for DAV at 75 mph.

| | FCW system activation |
|---|---|
| DAV | Threshold (feet) |
| 1.0 | 330 |
| 0.875 | 440 |
| 0.75 | 550 |
| 0.625 | 660 |
| 0.5 | 770 |
| 0.375 | 880 |
| 0.25 | 990 |
| 0.125 | 1100 |
| 0.0 | 1210 |

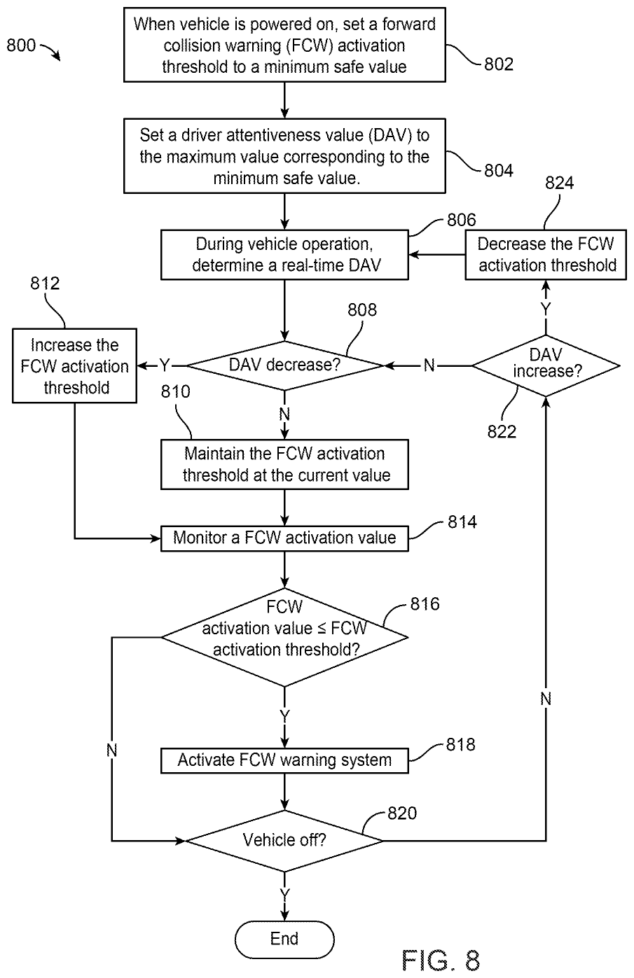

Returning to the description of the method 300, at step 310, the method 300 includes using the FCW system activation threshold to control the operation of the FCW system. The FCW system activation threshold can be used to control the operation of the FCW system as depicted in the method described below in conjunction with FIG. 8. After step 310, the method 300 ends.

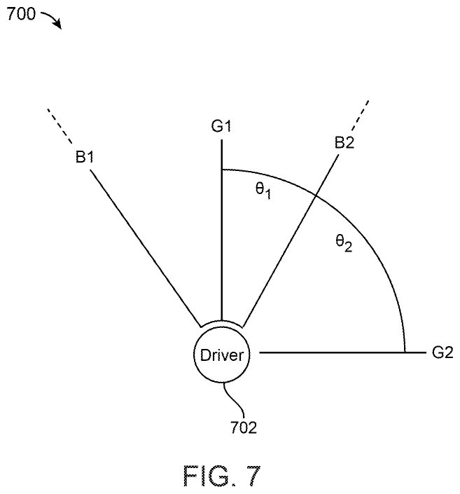

In another example, the driver attentiveness value (DAV) is determined using the algorithm below. FIG. 7 is a diagram 700 illustrating examples of driver gaze zones that are used with the algorithm to determine the driver attentiveness value (DAV). The diagram 700 includes a driver 702. B1 and B2 are gaze boundaries that are the limits of where the driver 702 should be looking. G1 and G2 are examples of driver gazes (G1 is a forward driver gaze and G2 is a side driver gaze). Θ1 is a first gaze angle measured between G1 and B2. Θ2 is a second gaze angle measured between G2 and B2. In this example, the driver attentive value (DAV) is determine using the following formula:

$${A}_{n} = {A}_{( n - 1 )} + ( B - G ) * {K}_{g} * Δ T$$

Where:

$$0.0 \leq {A}_{n} \leq 1.$$

Where:
Aₙ=Attentiveness score calculated for the current cycle
A (n-1)=Attentiveness score for the previous cycle
B=Angle to the closest boundary edge
G=Gaze angle
Kg=Internal factor to convert deviation error to attentiveness score
ΔT=Time since the last attentiveness calculation.

And where:
Kg=a constant value+a modifier (M)
M=a value determined by additional detected states (for example, if the driver is asleep or detected to be impaired)

The formula above is based on driver gaze error measured from predefined zones. There can be multiple predefined zones in the driver compartment. This approach factors in dead zones in which a driver can look without being deemed inattentive. Further, it accounts for the degradation of the driver attentiveness score over time due to the magnitude and length of the gaze error angle.

Referring now to FIG. 8, an example method of controlling a vehicle operation based on a driver attentiveness value is shown and is generally designated 800. The steps of the method 800 may be executed by the distributed system 100 depicted in FIG. 1 or the centralized system 200 depicted in FIG. 2. In the case of the distributed system 100, the steps of the method 800 may be executed by the processor 114 of the interior monitoring system 110, the processor 124 of the advanced driver-assistance system 112, or a combination thereof. On the other hand, in the case of the centralized system 200, the steps of the method 800 may be executed by the processor 214.

As shown in FIG. 8, the method 800 begins at step 802. At step 802, when a vehicle is powered on, the method 800 includes setting forward collision warning (FCW) activation threshold to a minimum safe value. That minimum safe value may include a distance between the primary vehicle 102 and the secondary vehicle 104 as measured in feet for a particular speed. For example, at 55 mph, the minimum safe value may be 242 feet (corresponding to a three second gap between the primary vehicle 102 and the secondary vehicle 104). At 65 mph, the minimum safe value may be 286 feet (corresponding to a three second gap between the primary vehicle 102 and the secondary vehicle 104). At 75 mph, the minimum safe value may be 330 feet (corresponding to a three second gap between the primary vehicle 102 and the secondary vehicle 104). At step 804, the method 800 includes setting a driver attentiveness value (DAV) to the maximum value (e.g., 1.0) that corresponds to the minimum safe value of the FCW system activation threshold.

Moving to step 806, during vehicle operation, the method 800 includes determining a driver attentiveness value (DAV) via an interior monitoring system (IMS). In one example, the DAV may be determined as shown in the method illustrated in FIG. 3. In another example, the DAV may be determine using the algorithm described above in conjunction with FIG. 7. At decision step 808, the method 800 includes determining whether the DAV decreases. If the DAV has not decreased, the method 800 moves to step 810 and the method 800 includes maintaining the FCW system activation threshold at the current value. Returning to decision step 808, if the DAV decreases, the method 800 proceeds to step 812 and the method 800 includes increasing the FCW system activation threshold. For example, increasing the FCW system activation threshold can include increasing the safe distance between the primary vehicle 102 and the secondary vehicle 104 as shown in Tables 3-5 above.

From step 810 and step 812, the method 800 proceeds to step 814 and includes monitoring a FCW system activation value, e.g., the distance between the primary vehicle 102 and the secondary vehicle 104. In one example, the FCW system activation value may be monitored using an exterior sensor 130, 230 placed in a forward location on the primary vehicle 102. The exterior sensor 130, 230 can use lidar or similar technology to determine the distance between the primary vehicle 102 and the secondary vehicle 104. Returning to the descript of the method 800, at decision step 816, the method 800 includes determining whether the FCW system activation value is less than or equal than current FCW system activation threshold. If so, the method 800 moves to step 818 and includes activating a FCW system 136, 236. For example, an audible signal may be emitted from the sound emitter 140, 240 while at the same time, a visual signal may be presented on the display 142, 242, or a combination of both may occur simultaneously or nearly simultaneous. From step 818, the method 800 continues to decision step 820.

Returning to decision step 816, if the FCW system activation value is not less than or equal to the FCW system activation threshold (i.e., FCW system activation value is greater than the FCW system activation), the method 800 also moves to decision step 820. At decision step 820, the method 800 includes determining whether the primary vehicle 102 is off. If so, the method 800 ends. Otherwise, if the primary vehicle 102 remains on and in operation, the method 800 proceeds to decision step 822 and the method 800 includes determining whether the DAV increases. If not, the method 800 returns to decision step 808 and continues as described herein. Otherwise, at decision step 822, if the DAV increases, the method 800 proceeds to block 824 and includes decreasing the FCW system activation threshold. Thereafter, the method 800 returns to step 806 and continues as described herein.

Thus, examples, aspects, and features herein provide, among other things, systems and methods for determining a driver attentiveness value and using the driver attentiveness value to control a vehicle operation (e.g., a forward collision warning system) based on the driver attentiveness value.

1. A system for controlling a forward collision warning system based on a driver attentiveness value, the system comprising:
a plurality of sensors; and
an electronic processor, the electronic processor configured to:
determine a gaze angle of a driver using the plurality of sensors;
determine a driver attentiveness value based on the gaze angle;
determine a forward collision warning system activation threshold based on the driver attentiveness value; and
selectively activate the forward collision warning system based on the forward collision warning system activation threshold.

2. The system of claim 1, wherein the electronic processor is configured to:
monitor a forward collision warning system activation value; and
activate the forward collision warning system when the forward collision warning system activation value is less than the forward collision warning system activation threshold.

3. The system of claim 1, wherein the gaze angle is measured between a longitudinal axis of a vehicle and a direction in which the driver is looking.

4. The system of claim 1, wherein the plurality of sensors includes at least a time-of-flight camera with a field of view of an interior of a vehicle.

5. The system of claim 4, wherein the time-of-flight camera determines a direction in which the driver is looking, a head position of the driver, a body position of the driver, or a combination thereof to determine the gaze angle.

6. The system of claim 5, wherein the gaze angle is compared to a lookup table of predetermined gaze angles to determine the driver attentiveness value.

7. The system of claim 6, wherein the driver attentiveness value decreases as the gaze angle increases.

8. The system of claim 6, wherein the driver attentiveness value is compared to a lookup table of predetermined driver attentiveness values to determine the forward collision warning system activation threshold.

9. The system of claim 6, wherein the forward collision warning system activation threshold increases as the driver attentiveness value decreases.

10. A system for controlling a forward collision warning system based on a driver attentiveness value, the system comprising:
a plurality of sensors; and
an electronic processor, the electronic processor configured to:
determine a driver attentiveness value for a driver;
modifying a forward collision warning system activation threshold based on the driver attentiveness value; and
selectively activate the forward collision warning system based on the forward collision warning system activation threshold.

11. The system of claim 10, wherein the driver attentiveness value is at least partially based on a gaze angle of the driver and the gaze angle is determined based on a direction in which the driver is looking, a head position of the driver, a body position of the driver, or a combination thereof.

12. The system of claim 11, wherein the plurality of sensors includes a time-of-flight camera and the time-of-flight camera detects the direction in which the driver is looking, the head position of the driver, the body position of the driver, or a combination thereof.

13. The system of claim 11, further comprising a memory coupled to the electronic processor, the memory including a first lookup table that includes a plurality of predetermined gaze angles and a plurality of driver attentiveness values, wherein each of the plurality of driver attentiveness values is associated with a respective predetermined gaze angle.

14. The system of claim 13, wherein the memory further includes a second lookup table that includes a plurality of forward collision warning system activation thresholds and the plurality of driver attentiveness values, wherein each forward collision warning system activation threshold is associated with a respective driver attentiveness value.

15. A method of controlling a forward collision warning system based on a driver attentiveness value, the method comprising:
determining a driver attentiveness value for a driver;
determining a forward collision warning system activation threshold based on the driver attentiveness value; and
selectively activating the forward collision warning system based on the forward collision warning system activation threshold.

16. The method of claim 15, further comprising:
monitoring a gaze location associated with the driver using a time-of-flight camera having a field of view of an interior of a vehicle in which the driver is located, wherein the gaze location is based on a direction in which the driver is looking, a head position of the driver, a body position of the driver, or a combination thereof.

17. The method of claim 16, further comprising:
determining a gaze angle from the gaze location, wherein the gaze angle is measured between a gaze axis aligned with the gaze location of the driver and a drive axis aligned with a longitudinal axis of the vehicle.

18. The method of claim 17, further comprising:
comparing the gaze angle to a gaze angle lookup table to determine the driver attentiveness value.

19. The method of claim 18, further comprising:
comparing the driver attentiveness value to a driver attentiveness value lookup table to determine the forward collision warning system activation threshold.

20. The method of claim 19, further comprising:
monitoring a forward collision warning system activation value; and
selectively activating the forward collision warning system when the forward collision warning system activation value is less than the forward collision warning system activation threshold.
